(19) United States
(12) Patent Application Publication
(10) Pub. No.: US 2025/0066105 A1
(43) Pub. Date: Feb. 27, 2025

(54) FOOD HOLDER FOR TOASTER

(71) Applicant: Revolution Cooking, LLC, Woburn, MA (US)

(72) Inventors: Philip C. Carbone, North Reading, MA (US); Thomas L. Klaff, Bethesda, MD (US); James Poon, Woburn, MA (US); Ryan O'Donnell, Ipswich, MA (US); Stephen G. Schimoler, Gates Mills, OH (US)

(73) Assignee: Revolution Cooking, LLC, Woburn, MA (US)

(21) Appl. No.: 18/809,414

(22) Filed: Aug. 20, 2024

Related U.S. Application Data
(60) Provisional application No. 63/682,395, filed on Aug. 13, 2024.
(60) Provisional application No. 63/520,960, filed on Aug. 22, 2023.

(51) Int. Cl. B65D 81/34; B65D 25/00

(52) U.S. Cl. CPC B65D 81/3492; B65D 25/005; B65D 2525/281

(57) ABSTRACT

A food holder for use with a cooking appliance, such as a toaster or oven. Sidewalls of the holder that define a space in which a food item is received. The sidewalls may be secured by engagement features, e.g., components that can be plastically deformed to secure portions of the sidewall relative to each other. A handle attached to the sidewalls may have a grip portion that is movable relative to a sidewall to which the handle is attached, e.g., by bending a portion of the handle. Lateral end walls and/or a bottom wall can be pleated or otherwise arranged to accommodate movement of the sidewalls towards each other, e.g., when compressing a food item between the sidewalls.

### BACKGROUND

Toasters are widely known for toasting or otherwise heating bread and other food products. Some toasters are arranged with one or more vertical slots or cavities into which bread or other food product is received. Heating elements on opposite sides of the vertical cavity operate to heat the food product, after which the food product is removed from the cavity, e.g., by a lift arm moving the food product upwardly at least partially out of the cavity. This allows a user to grasp the food product for removal.

### SUMMARY

In some aspects of the disclosure, a food holder is described that can be used with a toaster or other cooking appliance. For example, a sandwich or other food item can be provided in a space of the food holder, e.g., between sidewalls of the holder, and the holder inserted into a vertical cooking cavity of a toaster for heating the sandwich. In some cases, the food holder can be arranged for a single use, e.g., made of relatively lightweight and/or inexpensive materials. For example, the food holder can be assembled with a refrigerated or frozen sandwich or other food item and sold to a customer in a form ready to be inserted into a toaster for heating (after possibly removing an overwrap or other outer packaging from the assembled food holder and food item). In some cases, a food item may be assembled with a food holder (e.g., so the food item is compressed or otherwise held between sidewalls of the food holder), and the assembled food holder and food item contained in an airtight or other enclosure, such as a vacuum sealed overwrap or other package. The food item and food holder can be removed from the overwrap and placed in a toaster or other cooking device. The food holder can provide various functions such as enabling a user to easily manipulate the food holder and food item for placement in and/or removal from a toaster, provide a suitable enclosure for a food item for storage, handling and/or during heating, provide heat transfer features, and others.

As discussed more below, the food holder may be configured to provide specific heating conditions for the food item so the food item is heated in a particular way. For example, the food holder can include convex surfaces at the inner side of the holder that contact the food item and increase a surface area for transferring heat by conduction to the food item. This can help heat the food item more rapidly (e.g., as compared to a planar surface) and/or provide grill marks, caramelization or other areas that receive more heat than other areas of the food item. In some cases, the food holder can include openings that are configured to provide a desired level of steam or other vapor release from the food item during heating, e.g., to provide a desired level of moisture at outer and/or inner portions of the food item. As an example, heating of the food item and vapor release through the openings may provide a crispy, caramelized or otherwise relatively dry outer surface along with a suitably moist interior. In some embodiments, the food holder may fully enclose the food item in a completely enclosed space, e.g., so that exit of steam and/or other materials from the space in which the food item is held is resisted by the food holder. Such heating characteristics can be provided with a relatively low-cost food holder, e.g., that can be assembled and sold with a finished food item so that the assembled food holder and food item can be placed in a toaster. Thus, the customer can obtain a heated food item with relatively minimal effort and a food holder can be specially designed to operate with the particular food item with which it is assembled.

In some embodiments, a food holder can be configured for use with a toaster having a vertical cavity to receive and heat a food item and a plurality of heating elements associated with the vertical cavity. The holder can include first and second sidewalls that are spaced apart from each other and define a space between the sidewalls to receive the food item. In some cases, the first and/or second sidewalls can have a plurality of ridges that extend inwardly from an inner side of the sidewall into the space and/or a plurality of openings that extend through the sidewall. Each of the ridges can define a concave shape or surface at an outer side of the first or second sidewall and/or a convex shape or surface at an inner side of the first or second sidewall. In some cases, each of a plurality of openings can be positioned between adjacent ridges, e.g., the ridges and openings can be oriented vertically on the sidewall(s) with openings positioned between adjacent ridges. The plurality of openings may be configured to permit steam emitted by the food item to escape the space, and the plurality of ridges may be configured to transfer heat by conduction to the food item and to receive at least a portion of a corresponding heating element into the concave shape. In some cases, one or both sidewalls may include no openings and/or ridges, e.g., the sidewalls may be made of a completely impermeable and/or unperforated sheet material such as aluminum. In some cases, one or both sidewalls may define a concave shape in which a part of the food item may be received, e.g., concave shapes at an inner side of the sidewalls may together define a space in which a food item is received.

In some cases, one or both sidewalls may include engagement features at a periphery or other location of the sidewalls that are configured to be manipulated to secure the first and second sidewalls to each other and/or to disconnect the first and second sidewalls from each other to remove the food item from the space. For example, the engagement features may include a manually manipulable, plastically deformable element to secure a portion of the first and second sidewalls together, such as an aluminum or other malleable metal element that can be bent by hand to engage with a portion of one or more sidewalls to secure the sidewalls to each other and/or moved to disengage the sidewalls. In some cases, engagement features may be configured to be moved between an engaged and disengaged position multiple times, e.g., so that the sidewalls can be used multiple times with different food items for heating. Engagement features may in some cases be moved by hand and without tools, e.g., by manipulating elements by thumb and forefinger. Peripheries of the sidewalls may be circular, oval, rectangular or otherwise shaped, and the sidewalls may have top, bottom and opposed lateral sides, e.g., a circular periphery with top, bottom and lateral sides. Engagement features may be positioned at lateral sides, top and/or bottom areas of the sidewalls. The first and second sidewalls secured together by the engagement features may be configured for insertion into the vertical cavity to heat the food item in the space between the first and second sidewalls, e.g., the engagement features may be configured to withstand heating and/or other conditions associated with heating in a toaster or other cooking device. In some embodiments, engagement features may include a first flange on the periphery of a first sidewall and a second flange on the periphery of a second sidewall. The first flange may be configured to receive and be plastically deformed around a portion of the second flange to secure the first and second sidewalls together. For example, the first flange can have an annular shape with an L shaped cross section and the second flange can have a flat annular shape. The second flange may be received into a cylindrical, tubular or otherwise shaped space defined by the first flange, e.g., so the second flange contacts a part of the first flange, and a portion of the first flange may be bent to capture a part of the second flange between portions of the first flange. More details regarding such an engagement feature and other engagement feature arrangements are discussed further below.

In some embodiments, first and second lateral ends of the first and second sidewalls may be coupled together and configured for insertion into the vertical cavity to heat the food item in the space between the first and second sidewalls. The food holder can include first and second lateral end walls extending between the first and second sidewalls at first and second lateral sides of the first and second sidewalls, and/or a bottom wall that extends between the first and second sidewalls at a bottom sides of the sidewalls. For example, the lateral end walls and/or the bottom wall can enclose the lateral sides or bottom of the space in which the food item is held, e.g., to prevent steam, liquid or other materials released from the food item from passing through the lateral sides of the space. The top may be open or include one or more wall elements, e.g., to enclose the top area. In some cases, the first and second lateral end walls, top wall and/or the bottom wall can include pleats to permit the first and second sidewalls to be moved towards each other. For example, to provide a sandwich press-type function, the first and second sidewalls may be moved together to squeeze the food item between the sidewalls (and press ridges, if present, into contact with the food item). To accommodate this movement of the sidewalls together, the lateral end walls, top wall and/or the bottom wall may be pleated, e.g., have one or more fold lines, that allow the end walls to adjust to the reduced distance between the sidewalls while still enclosing the space in which the food item is positioned. In some embodiments, top or bottom wall portions and/or lateral end walls of the first and second sidewalls can overlap with each other, e.g., so that a majority of a width of at least one of the wall portions overlaps with a corresponding wall portion. The overlap arrangement may permit the sidewalls to be moved toward each other, e.g., so as to provide a variable distance between the sidewalls, while resisting exit of liquids or other materials through the lateral sides, top and/or bottom. For example, a close positioning or crimping of the overlapping top or bottom wall or lateral end wall portions may resist movement of liquids and/or gasses through any space between the wall portions. Thus, the food item can be pressed between the sidewalls while the lateral end walls and/or top or bottom wall keep the space enclosed to resist movement of materials from the food item out of the space.

In some cases, the first and second sidewalls can be configured to be moved towards each other by hand, e.g., a user can squeeze or otherwise move the sidewalls towards each other to press a food item in the space between the sidewalls. The sidewalls may be rigid, e.g., remain planar even when lateral sides of the sidewalls are forced to move toward each other to compress a food item between the sidewalls. In some cases, the sidewalls may be suitably rigid to cause the ridges and/or other surface shapes at the inner surface of the sidewalls to deform the food item. For example, convex portions of ridges may form concave depressions in the food item, e.g., so as to increase a surface area of the food item to receive conductive heat from the food holder. In some embodiments, the food holder can include engagement features at the first and second lateral sides and/or the bottom side and/or the top side of the first and second sidewalls that are configured to be engaged together by hand to secure the first and second sidewalls to each other and define a distance between the first and second sidewalls. For example, a user can move the sidewalls together to press a food item to a desired extent (if necessary), and then secure the engagement features to maintain a distance between the sidewalls. In some cases, the engagement features may be operated to move the sidewalls towards each other as well as secure the sidewalls at a desired distance from each other. Thus, the engagement features may be operable to pull the first and second sidewalls towards each other and reduce the distance between the first and second sidewalls. The engagement features may include any suitable components that are complementary to each other or otherwise are capable of securing the sidewalls at a desired distance from each other. For example, the engagement features can include at least one twist tie or wire components extending between the first sidewall and the second sidewall at the first and second lateral sides, top and/or bottom. The twist tic or wire components can be twisted or otherwise secured together to define a distance between the sidewalls. In some embodiments, the engagement features can include complementary sets of first and second tabs, with first tabs extending from the first and second lateral, bottom or top sides of the first sidewall and the second tabs extending from the first and second lateral, bottom or top sides of the second sidewall. The first and second tabs of each complementary set may be configured to engage with each other to define, at least in part, the distance between the first and second sidewalls. For example, the tabs may be configured to operate like a buckle with a first tab including an opening or otherwise defining a frame through which a complementary second tab can be threaded and secured. In some cases, the second tab can include a plastically deformable material, such as a metal, that allows the tab to be folded back on itself or otherwise bent and secure the first and second tabs together. In some embodiments, the engagement features may include a crimped attachment of portions of the sidewalls and/or lateral end walls and/or top wall and/or bottom wall. In some cases, the engagement features may include a channel or groove formed by a sidewall and attached lateral end walls configured to receive a corresponding sidewall. In some embodiments, the first and second lateral end walls may be configured to fold at pleats in response to movement of the first and second sidewalls towards each other by operation of the engagement features. In some cases, engagement features may include clamp elements, e.g., strips of malleable, plastically deformable metal, that can be bent to engage with portions of the first and second sidewalls to hold the sidewalls in place relative to each other. In some examples, the engagement features may provide for a range of distances between sidewalls, e.g., to accommodate food items of different thickness.

In some cases, the first and second sidewalls and/or the first and second lateral end walls and/or bottom or top walls may be formed of a rigid material or otherwise be configured to apply pressure or other force to a food item in the space between the sidewalls. This may enable the food holder to press on the food item during cooking, which may provide desired features such as improving conductive heat transfer from the food holder (e.g., at ridges on the sidewalls) to the food item, helping a food item to maintain a particular shape (e.g., where the food item is flimsy or otherwise incapable of holding a particular shape, such as when heated), or others. In some cases, the sidewalls and/or lateral end walls and/or bottom or top wall portions may be formed of a sheet material, such as an unperforated and/or impermeable sheet material, e.g., including metal, paper and/or other materials or combinations of materials such as laminates of metal and paper. As an example, the food holder may be made of an unperforated aluminum sheet that is stamped or otherwise formed to include ridges, openings, engagement features, fold lines or other features of the food holder. The sidewalls may be configured to be relatively rigid to apply pressure to the food item, e.g., in response to engagement features being used to pull the sidewalls toward each other. Thus, in some cases the sidewalls may remain planar even as lateral edges of the sidewalls are pressed together to compress a food item between the food item. Outer and/or inner surfaces of the food holder may be painted, coated or otherwise have a dark color, e.g., with a paint or other material that is red in color or otherwise configured to help absorb infrared or other heat energy. Some portions of the food holder, such as handles, engagement features or other portions intended to be manipulated by a user while the food holder is hot may have a reflective or light colored surface, e.g., to help dissipate heat.

In some cases, the first and second sidewalls may each have a top end and a bottom end, and the food holder further may include a bottom wall extending between the bottom ends of the first and second sidewalls and configured to enclose the space between the first and second sidewalls at a bottom of the space. The bottom wall may be configured to prevent materials, such as vapor and/or liquids, from the food item from exiting the space between the sidewalls. For example, the bottom wall may prevent oils or other liquids from the food item from dripping from the food holder and into the toaster. The bottom wall may include a single portion that is attached to and spans between bottom edges of the sidewalls, or may include bottom wall portions that extend from a respective sidewall. Bottom wall portions may overlap or otherwise be arranged to help resist exit of liquid or other materials from the space between the sidewalls. A food holder may include a bottom wall along with lateral end walls, or may include a bottom wall with no lateral end and/or top walls, e.g., the lateral sides and/or top of the space between the sidewalls may be open. Similarly, a food holder including lateral end walls may include, or not include, a bottom wall.

In some embodiments, the food holder may include a handle attached to one or both sidewalls, e.g., extending from a top end of the first or second sidewall, and the handle may be configured to permit grasping by hand to manipulate the food holder. For example, a user may grasp the handle to place the food holder in and/or remove the food holder from a toaster. A handle may be attached to the first and/or second sidewall, and the handle may be configured to support the first and second sidewalls for positioning the first and second sidewalls and the food item in a vertical cavity of a toaster or other cooking device, and/or for removing the first and second sidewalls and the food item from the vertical cavity. In some cases, the handle may include a grip portion that is movable relative to the first and/or second sidewall to which the grip is attached. For example, the handle may be configured for positioning the grip portion in a first position adjacent a sidewall and a second position away from the sidewall. For example, the grip position may be positioned adjacent a sidewall for packaging and shipping, and a user may move the grip portion away from the sidewall for placing the sidewalls and a food item in a toaster. In some cases, a part of the handle may be plastically deformable to permit movement of the grip portion between the first and second positions relative to the sidewall, and in some cases the grip portion may be movable between the first and second positions multiple times. In some embodiments, the grip portion may be positionable in a location that is between lateral ends of the first and second sidewalls and offset from planes of the first and second sidewalls such that a plane of the one sidewall is between a plane of the other sidewall and the grip portion. In some cases, the location may be above a top end of the sidewalls. This type of arrangement may permit the grip portion to be positioned to the side of a vertical cavity of a toaster in which the sidewalls and a food item are positioned. The handle may be arranged in various other ways, such as a tab that extends from a top edge or other portion of the food holder. Any such handle configurations can be used with any suitable features of a food holder, such as sidewalls including engagement features arranged as described above, or not.

In some embodiments, one or more guides or stops may be configured on one or both sidewalls. The guides or stops may be arranged to help position the food holder in a toaster cavity or other cooking space, e.g., help center the food holder in a cavity, and/or help define an extent to which the food holder is inserted into a cavity. In some embodiments, the first and/or second sidewalls can have a stop extending outwardly from a top end configured to resist movement of the holder into the vertical cavity beyond the stops. This can help prevent the holder from moving beyond a desired distance into the cooking cavity and/or help properly position the holder in the cooking cavity.

In some cases, the food holder may hold the food item in a relatively enclosed space, e.g., a space that does not permit vapor or liquids to pass through all or substantial portions of the food holder. For example, the first and second sidewalls may each include a plurality of openings that define an open area of the first sidewall, and a ratio of the open area to a closed area of the first and second sidewalls may be between zero and 40%, e.g., between 0% and 20%. Lateral end walls and/or a bottom wall may have no openings at all, e.g., have an open area of 0% to 20% or less, e.g., 0% to 10%. Such an arrangement may help the food holder prevent water vapor from leaving the space in which the food item is held and/or to better transfer heat by conduction to the food item (e.g., because of a relatively large surface area that is highly thermally conductive). In some cases, the sidewalls of the food holder may have a thermally conductive inner surface that faces the food item, e.g., to transfer heat by conduction to the food item.

In some embodiments, a plurality of ridges and a plurality of openings may extend along a direction from a top to a bottom of the first and second sidewalls. Each of the plurality of ridges can define an elongated convex shape at an inner side of the first and second sidewalls and define an elongated concave shape at an outer side of the first and second sidewalls. The concave shape of one or more ridges can be configured to be positioned adjacent a heating element in the cooking cavity, e.g., to receive a portion of the heating element if the heating element expands or otherwise moves during the cooking process and/or to receive and transfer heat from the heating element to the food item. In some cases, the plurality of ridges can be configured to transfer a greater amount of heat or transmit heat at a faster rate or spread heat delivery over a larger surface area to the space and the food item than a flat sidewall surface located in a same place on the sidewall as the ridge. Each of the openings can define an elongated slot, e.g., that extends in a direction of adjacent ridges. In some cases, the plurality of openings can be configured to permit steam emitted by the food item to escape the space. In some embodiments, each of the plurality of ridges has a larger surface area than an area of each of the plurality of openings. In some cases, the plurality of openings and/or the plurality of ridges may extend along a majority of the sidewalls, e.g., more than 50%, more than 60%, more than 70%, etc. of the height of the sidewall.

In some cases, the holder can be opened and closed to permit placement or removal of a food item into the holder. For example, the first and second sidewalls can each have a top end and a bottom end, and the first and second sidewalls can be coupled together at the bottom ends, e.g., by a bottom wall with one or more fold lines to permit movement of the first and second sidewalls relative to each other between an open position and a closed position. In some cases, the holder can include engagement features (e.g., at lateral edges of the sidewalls) to hold the first and second sidewalls in the closed position and configured to be released to allow movement of the sidewalls to the open position. In some cases, the first and second sidewalls can be configured to define an entrance opening to the space at a top of the space, e.g., to allow a food item to be placed into the space through the opening. Thus, the sidewalls need not be moveable between open and closed positions to receive a food item and/or allow a food item to be removed from the space. In short, a food holder can include any combination of features described herein at least to the extent the features are not mutually exclusive.

In some embodiments, a holder can be configured for use with a toaster having a vertical cavity to receive and heat a food item and a plurality of heating elements associated with the vertical cavity. The holder can have first and second sidewalls that are spaced apart from each other and define a space between the sidewalls to receive a food item. The first and second sidewalls can be coupled together and configured for insertion into the vertical cavity to heat the food item in the space between the first and second sidewalls. As an example, the first and second sidewalls can each having a top end, a bottom end and opposed first and second lateral ends. Engagement features may be provided at the first and second lateral sides and/or other portions of the first and second sidewalls (such as at a periphery) and be configured to be engaged together by hand or otherwise to secure the first and second sidewalls to each other and define a distance between the first and second sidewalls. For example, the engagement features, when disengaged, may permit the sidewalls to be moved to an open position to receive a food item. The sidewalls may be moved to a closed position, e.g., in which the sidewalls are adjacent the food item, and the engagement features engaged with each other to define a distance between the sidewalls. Thus, the first and second sidewalls may be coupled together by the engagement features and be configured for insertion into the vertical cavity to heat the food item in the space between the first and second sidewalls. In some cases, the sidewalls need not be movable between open and closed positions, but rather the engagement features may be employed to define a distance between the sidewalls. For example, a food item may be received into the space (e.g., via an opening defined by the top end of the sidewalls) and the sidewalls moved toward each other. The engagement features may be engaged to maintain a desired distance between the sidewalls. In some cases, the engagement features may be employed to move the sidewalls toward each other as well as maintain a desired distance between the sidewalls.

A food holder including engagement features can include any suitable features such as those mentioned above or elsewhere herein. For example, the engagement features may include twist tie or wire features that can be engaged, complementary sets of tabs or other features (e.g., that provide a buckle-type engagement), channel engagements, crimping, clamps, or other configurations. The holder in any embodiments may include any other features or suitable combinations of features as well. For example, the food holder may be open at lateral sides (e.g., have no lateral end walls), or may have lateral end walls (e.g., with or without pleats, fold lines or other features that permit the sidewalls to be moved toward each other). The food holder may be open at the bottom (e.g., have no bottom wall), or may have a bottom wall (e.g., with or without pleats or other features, with or without openings to prevent vapor or liquid from exiting the space) and so on. The sidewalls or other portions of the food holder may be formed of an unperforated sheet, a sheet of thermally conductive material, may include ridges and/or openings, may have a relatively low open area at the sidewalls and/or other portions of the food holder, and any other suitable features or combinations of features discussed herein. Other features or components described can be employed with the holder as well and are not repeated for brevity.

A food holder may be employed in a variety of different methods of use and/or assembly, e.g., with a food item, as described herein. For example, a method for using a food holder can include providing a food item in a space between first and second sidewalls, moving a grip portion of a handle attached to a first sidewall from a first position to a second position relative to the first sidewall, manipulating the grip portion of the handle to position the food item and the first and second sidewalls in the vertical cavity to heat the food item, and removing the food item from the vertical cavity of a toaster or other cooking device after heating the food item. Movement of the grip portion can include moving the grip portion from the first position adjacent the first sidewall and the second position away from the first sidewall, plastically deforming a part of the handle to move of the grip portion between the first and second positions, positioning the grip portion in a location that is between lateral ends of the first and second sidewalls and offset from planes of the first and second sidewalls such that a plane of the first sidewall is between a plane of the second sidewall and the grip portion, disengaging engagement features to remove the food item from a space between the sidewalls, and others. Another illustrative method of using a food holder may include providing a food item in a space between first and second sidewalls, where the first and second sidewalls are secured to each other by engagement features at a periphery of the first and second sidewalls. The engagement features may include a manually manipulable, plastically deformable element to secure a portion of the first and second sidewalls together, e.g., a malleable metal component may be bent to secure the sidewalls together. The food item and the first and second sidewalls may be positioned in a vertical cavity of a toaster or other device to heat the food item, the food item may be removed from the vertical cavity after heating the food item (e.g., by grasping a handle attached to the sidewalls), and the plastically deformable element may be disengaged by hand and without tools to remove the food item from the space.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is an upper front left perspective view of a holder for use with a toaster in an illustrative embodiment.

FIG. 2 is a front view of the FIG. 1 embodiment.

FIG. 3 is a top view of a food holder including buckle type and twist tie engagement features.

FIG. 4 is a side view of a food holder including twist tie engagement features.

FIG. 5 is a lower front left perspective view of a food holder having open lateral sides.

FIG. 6 is a perspective view of a food holder in which portions of one sidewall are received into a space defined by another sidewall.

FIG. 7 shows a top view of the FIG. 6 embodiment with an overwrap enclosing the assembled food item and food holder.

FIG. 8 shows a top view of an embodiment in which a sidewall and lateral end walls define a channel in which another sidewall is received.

FIG. 9 is a top view of an embodiment in which sidewalls are engaged by crimping one or more portions of the sidewall, lateral end wall and/or bottom wall portions together.

FIG. 10 shows an upper front right perspective view of a food holder having engagement features at top, bottom and lateral sides of a sidewall.

FIG. 11 shows a lower front left perspective view of the FIG. 10 embodiment.

FIG. 12 shows an upper rear left perspective view of the FIG. 10 embodiment.

FIG. 13 shows a lower rear right perspective view of the FIG. 10 embodiment.

FIG. 14 shows a front view of the FIG. 10 embodiment.

FIG. 15 shows a rear view of the FIG. 10 embodiment.

FIG. 16 shows a left side view of the FIG. 10 embodiment.

FIG. 17 shows a left side view of the FIG. 10 embodiment in an assembled position.

FIG. 18 shows a perspective view of the FIG. 10 embodiment positioned in a vertical cavity of a toaster.

FIG. 19 shows a toaster with which a food holder can be used by inserting the holder into a cooking cavity of the toaster.

FIG. 20 is a cross sectional view of the FIG. 10 toaster along the line 11-11 in FIG. 6.

### DETAILED DESCRIPTION

Various embodiments will be described in detail with reference to the drawings, wherein like reference numerals represent like parts and assemblies. Reference to various embodiments does not limit the scope of the claims. Additionally, any examples set forth in this specification are not intended to be limiting and merely set forth some of the many possible embodiments for the claims. Aspects of the disclosure can be used individually and/or in any suitable combination with each other. For example, a holder is described having one or more sidewalls with one or more ridges that define a convex surface at an interior of the sidewall. A holder is also described having lateral end walls and/or a top wall and/or a bottom wall with pleats, overlapping portions or other arrangements to permit sidewalls of the holder to be moved towards each other. A holder is also described having engagement features at lateral ends and/or a bottom end and/or a top end of the sidewall to define a distance between the sidewalls or to otherwise secure the sidewalls together. These features and other features described herein can be used alone in a holder, or can be combined together in any suitable way. For example, a holder having a sidewall with ridges and lateral end walls can be provided with or without engagement features at the lateral ends, the top or bottom of the sidewalls. Or a holder having sidewalls with engagement features at the lateral, top or bottom ends can be provided without lateral end walls and/or without ridges at internal surfaces and/or with or without a handle. Alternately, a holder with lateral end walls and engagement features at lateral, top or bottom ends of sidewalls having no ridges and/or openings can be employed. These are just a few examples and it should be understood that any suitable combination of features may be employed even though such an embodiment is not expressly described.

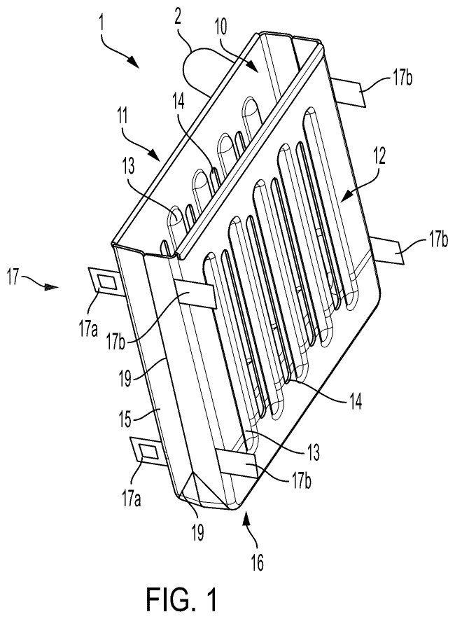

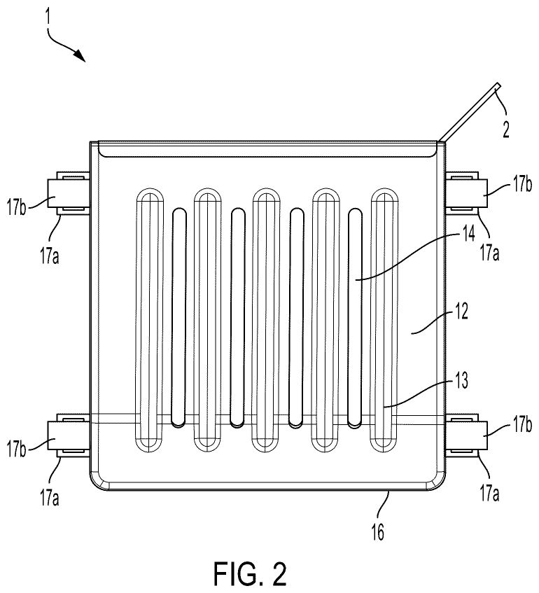

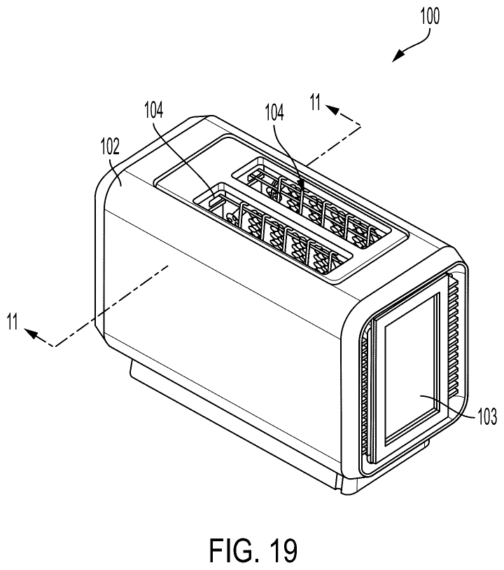

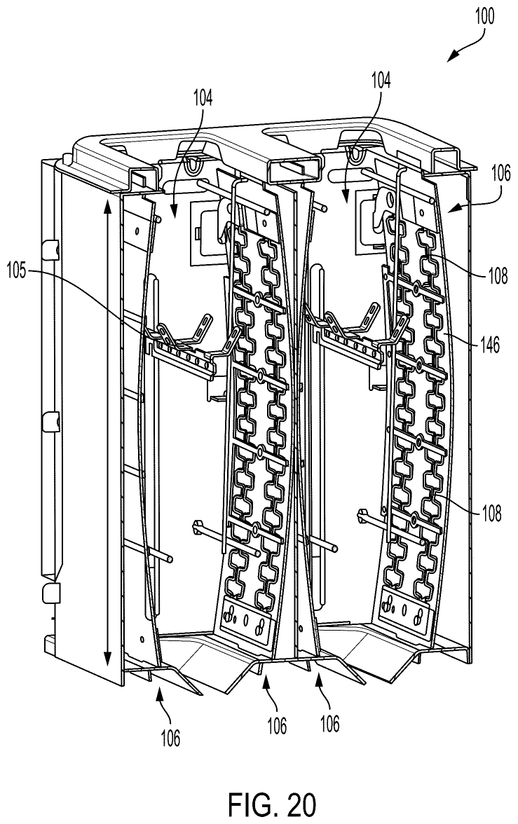

FIGS. 1 and 2 show an illustrative embodiment of a holder 1 that is configured for use with a toaster, e.g., having a vertical slot or cavity that typically receives a piece of bread or other food item for toasting or otherwise heating the food item. In the case of a holder 1 like that in FIGS. 1 and 2, a food item such as a sandwich can be placed in the holder 1 and the holder 1 positioned in the cooking cavity of the toaster for heating. One such toaster 100 is shown in FIGS. 19 and 20 and has a pair of cooking cavities 104 to receive a food item alone or to receive a holder 1 for heating an item held by the holder 1. As will be appreciated by those of skill in the art, a food item heated in the holder 1 can experience various cooking processes such as toasting, broiling, drying, roasting, etc., all of which are referred to herein as cooking or heating. Also, although the various embodiments of a holder 1 discussed herein are described with reference to a “sandwich,” aspects of the disclosure related to a holder are not limited to use with any particular food item, such as a sandwich. Likewise, while the term “holder” may suggest that a food item is squeezed or compressed when held by the holder, but such squeezing or compression is not required. Thus, a holder can receive non-sandwich food items, such as a meat patty or bread item, and/or the food items can be held loosely and without compression by the holder. FIGS. 19 and 20 show an illustrative toaster 100 that has a vertical cooking cavity 104 that can receive the holder 1. The toaster 100 in this example includes a housing 102 with a user interface 103 at a front side of the housing 102 and openings at an upper surface of the housing 102 that lead to the cooking cavities 104, as is commonly found in toasters. The cooking cavities 104 each have heating element assemblies 106 that provide heat, e.g., in the form of radiant energy, to items in the cooking cavity 104. The heating element assemblies 106 in this illustrative arrangement include a support 146 that supports one or more heating elements 108 which emit radiant energy when an electrical current is passed through the element 108. The elements 108 are oriented to extend vertically in the cooking cavity 104, which is relevant to features of the illustrative holder 1 described below. That is, as detailed below, a holder can have ridges that present a concave surface on an outer side of the holder sidewalls toward a corresponding heating element 108, and thus the ridges may be sized, shaped and oriented in a way that corresponds or otherwise functions with heating elements 108 of a toaster. Each cooking cavity 104 can have a lift arm 105 that supports a food item or holder 1 received in the cooking cavity 104 and can be movable to lower and/or lift an item with respect to the cavity 104. However, it should be understood that holder arrangements discussed herein are not limited to use with any particular toaster, such as the one shown in FIGS. 19 and 20, and/or with cooking appliances having vertical cooking cavities, and/or with cooking cavities having heating elements arranged in any particular way. Instead, a holder can be configured for use with any cooking appliance, such as toaster ovens, grills, etc., may be provided into a cooking cavity in a horizontal or other direction as opposed to vertical, and may be used with cooking cavities having any suitable heating element or other configuration.

In some aspects of the disclosure, a holder can have first and second sidewalls that are spaced apart from each other and define a space between the sidewalls to receive a food item. As an example, an opening to the space can be provided at an upper end of the sidewalls to receive a food item and/or the sidewalls can be moveable relative to each other (e.g., between a closed position and an open position to allow access to the space) and/or to at least partially compress or squeeze the food item in the space or to otherwise reduce a distance between the sidewalls of the holder and the food item. One or both of the sidewalls can have a plurality of ridges or other convex features that extend inwardly from an inner side of the sidewall into the space where the food item is located. In some embodiments, the ridges can each be configured to present a convex surface at the inner side of the sidewall and a concave surface at an outer side of the sidewall. In some cases, one or both sidewalls can have a plurality of openings that extend through the sidewall, e.g., openings in the sidewall can be positioned between adjacent ridges. The ridges can provide various functions in addition to providing a raised surface in the space between the sidewalls to exert force on a food item in the space. For example, when a holder is received in a cooking cavity of a toaster, the ridges can be configured to be positioned adjacent a heating element in the cooking cavity and so receive radiant, conductive and/or convective heat from the heating element. As an example, a ridge can be configured to define an elongated convex surface at an inner side of a sidewall and a concave surface at an outer side of the sidewall. The ridges can be formed, for example, by stamping or otherwise deforming a metal or other sheet material so as to form the convex and concave features. A heating element, e.g., of a toaster, can extend along the concave surface of the ridge when the holder is received in the cooking cavity and provide heat to the concave surface of the ridge. Since the concave surface provides an increased or larger surface area to receive heat from the heating element as compared to a flat surface, the concave surface can receive and transmit a greater amount of heat or transmit heat at a faster rate or spread heat delivery over a larger surface area to the space and the food item than a flat surface. This can allow the holder to heat a food item faster and/or otherwise more effectively. In some cases, the sidewalls of the holder and/or portions of the sidewall that form the ridges may be formed of a thermally conductive material such as a sheet of metal material. This may aid in conductive heat transfer between the sidewall and the food item in the space. The sheet of material may be unperforated, e.g., having no holes or openings, at least at the ridge areas. Another possible advantage of providing a concave surface facing heating elements of a toaster is that if a heating element thermally expands or otherwise moves so that the heating element moves closer to the holder during a cooking operation, a concave surface of the ridge that faces the heating element can provide an area into which the expanding heating element can move without contacting the holder sidewall. As will be understood, contact between a heating element and a holder may be undesirable, e.g., because an electrical short circuit may be created and/or heat may be transferred from the element to the holder in the contacting area faster or to a greater extent than is desirable. Thus, ridges can provide an area at an external or outer side of the sidewall to receive a portion of a heating element and/or in which a heating element can move while minimizing chances that the heating element will directly contact the sidewall.

In some cases, the ridges can be made closed, i.e., have no openings through the sidewall, and of a thermally conductive material. Where the ridges are positioned adjacent a heating element in a cooking cavity, this configuration can allow the ridges to spread heat more evenly over the interior convex surface of the ridge and to a food item than a similarly sized opening or flat sidewall surface. Another potential feature provided by the ridges is to provide areas between the sidewall and the food item where the sidewall does not contact the food item or contacts the food item with less force or surface area. This can allow steam, grease or other items to flow more easily between the food item and the sidewall in the interior space of the holder. In the case of steam, it may be desirable to allow steam to escape the space where the food item is located, e.g., through a top opening of the space, and reduced contact areas between adjacent ridges may provide an escape path. In embodiments where openings are provided between adjacent ridges, the reduced or non-contact areas near ridges can provide a path for steam and/or other materials to escape from the space through the openings.

In some embodiments, one or both sidewalls of the holder can be relatively closed, e.g., have a ratio of open area to total surface area of the sidewall that is zero to 40%, e.g., zero to 20%. This configuration can be employed whether one or both sidewalls have ridges or other internal surface features or not. This is in contrast to food holding devices that employ a wire cage or mesh to hold a food item. A wire cage or mesh has a relatively large ratio of open area to total surface area and so allows steam, grease and other materials to easily escape from a food item as well as allow radiant heat to travel directly from a heating element to the food item. Either or both of these features may be undesirable, e.g., because readily escaping steam may allow a food item to dry out and some portions of the food item may receive too much heat or be heated too quickly in relation to other areas because a heating element can direct radiant heat to some food item areas but not others. In contrast, a holder that has a reduced open area can control steam and other material escape as well as better control how heat is transferred to the food item.

As noted above, the holder 1 shown in FIGS. 1 and 2 includes one or more of the features described above. That is, the holder 1 in some embodiments includes first and second sidewalls 11, 12 that are spaced apart from each other and define a space between the sidewalls 11, 12 to receive a food item. The sidewalls 11, 12 can be arranged to provide an opening 10 to the space at an upper end of the sidewalls 11, 12 to receive a food item, although in some cases the space can be enclosed at an upper end of the sidewalls 11, 12, e.g., by upper or top wall portions that extend inwardly from an upper or top end of a sidewall toward the opposing sidewall. In some embodiments, the sidewalls 11, 12 can be moveable relative to each other between an open position to allow access to the space and a closed position to at least partially enclose the food item in the space. For example, the sidewalls 11, 12 can be coupled by a bottom wall 16 of the holder 1 or in another location, such as at a lateral end wall 15 of the sidewalls 11, 12. The bottom wall 16 and/or a lateral end wall 15 may include a fold line, living hinge or other feature that permits the sidewalls 11, 12 to be moved apart to an open position to receive a food item between the sidewalls 11, 12 and together to a closed position, e.g., to contact, compress or otherwise position the food item between the sidewalls 11, 12. This can squeeze the food item between the sidewalls 11, 12 or otherwise position the food item in the space between the sidewalls 11, 12 for heating. Note that a hinge or other coupling between the sidewalls 11, 12 is not required and the sidewalls 11, 12 can be coupled together in other ways, or not coupled at all. For example, the sidewalls 11, 12 can be configured to be completely separable from each other, and then positioned adjacent each other and joined, e.g., by one or more hooks, latches, clips, straps, fasteners or other engagement features, in the closed position. Thus, the first and second sidewalls 11, 12 can be coupled together in any suitable way and configured for insertion into the vertical cavity of a toaster to heat the food item in the space between the sidewalls.

Thus, in some embodiments, a food holder may include one or more engagement features 17 to define a distance between the sidewalls 11, 12, e.g., to compress a food item between the sidewalls 11, 12 or otherwise define a size of the space in which the food item is held. In some cases, the engagement features 17 may operate to define a maximum distance between the sidewalls 11, 12. For example, a food item may be placed in the space between the sidewalls 11, 12 and the engagement features 17 engaged to define a maximum distance by which the sidewalls 11, 12 may be separated. In some examples, the engagement features 17 may provide for a range of distances between the sidewalls 11, 12, e.g., so that the holder 1 can be used with different thickness food items. In some cases, the engagement features 17 may hold the sidewalls 11, 12 so that the sidewalls 11, 12 compress or otherwise exert a force on the food item. For example, a user may squeeze or otherwise force the sidewalls 11, 12 together so as to compress a food item between the sidewalls 11, 12 and then secure the engagement features 17 so that the sidewalls 11, 12 cannot move apart. In some cases, a compressive force or other force to move the sidewalls 11, 12 together may be provided by a vacuum sealing operation, e.g., that positions the food holder 1 and food item between the sidewalls 11, 12 in a bag or other container from which air is evacuated. Evacuation of the bag or other outer container may exert a force of atmospheric pressure on the outer container, and thus on the sidewalls 11, 12 to move the sidewalls 11, 12 together. In some embodiments, a compressive force may be provided by a user (e.g., squeezing the sidewalls together by hand) or a clamp or other mechanical device. The sidewalls 11, 12 may be rigid so that the sidewalls 11, 12 remain planar while compressing the food item in the space. Such movement may cause ridges on the sidewalls 11, 12 (if present) to deform the food item, e.g., so the food item conforms at least partially to the convex shape of the ridges 13.

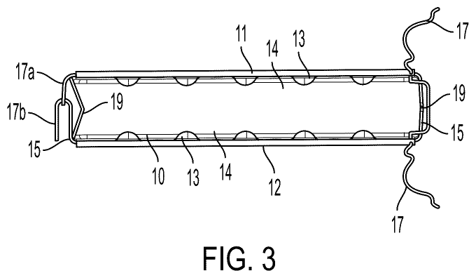

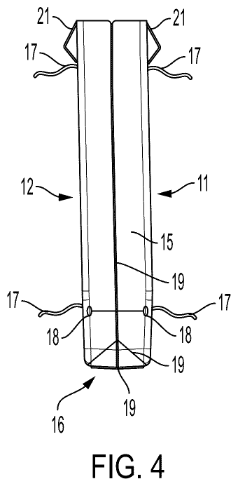

With the food item held in the space, the engagement features 17 may be secured to keep the sidewalls 11, 12 from moving apart. In some embodiments, the engagement features 17 may be employed to move the sidewalls 11, 12 together as well as define a maximum distance between the sidewalls 11, 12. For example, the engagement features 17 may include a ratchet, buckle or other configuration that permits a user to operate the engagement features 17 to cause the engagement features 17 to pull the sidewalls 11, 12 toward each other. The engagement features 17 may be secured to resist movement of the sidewalls 11, 12 away from each other. The embodiment in FIGS. 1 and 2 show engagement features 17 that provide a buckle-type engagement although other arrangements are possible. In the FIGS. 1 and 2 embodiment, the engagement features 17 include first and second tabs 17a, 17b that are configured to be engaged together by hand or machine to secure the sidewalls 11, 12 to each other and define a distance between the sidewalls 11, 12. The first and second tabs 17a, 17b may be complementary sets of tabs, with each tab extending from the lateral side of a respective sidewall as shown, and/or from a bottom side of a respective sidewall. The first tabs 17a may include a buckle arrangement, e.g., defining a buckle frame with an opening through which the second tab 17b can be extended. The second tab 17b can be secured to the first tab 17a in any suitable way, such as by a prong on the first tab 17a that engages with a hole or other portion of the second tab 17b (e.g., as is common with belt buckles). In some cases, the second tab 17b may include a plastically deformable material, such as a malleable metal, that permits the second tab 17b to be extended through the opening of the first tab 17a after which the second tab 17b can be folded back on itself to secure the first and second tabs 17a, 17b together. Folding of the second tab 17b may deform the plastically deformable material and cause the material to retain the deformed shape, e.g., the folded over tab 17b may remain in the folded over position until physically moved by a user. Such an engaged state with a folded over second tab 17b can be seen on the left in FIG. 3. Some engagement feature 17 arrangements may permit a user to operate the engagement features 17 to pull the sidewalls 11, 12 toward each other as well as secure the sidewalls 11, 12 to define a distance between the sidewalls 11, 12. For example, in the arrangement of FIGS. 1 and 2, the second tab 17b can be threaded through the opening of the first tab 17a and the second tab 17b can be pulled to draw the first tab 17a and the first sidewall 11 toward the second tab 17b and the second sidewall 12. Other arrangements are possible for the engagement features 17, including one or more hooks, latches, clips, straps, zip ties or other fasteners. For example, the right side of FIG. 3 and FIG. 4 show an alternative engagement features 17 arrangement that includes one or more twist tie or wire segments that can be secured together. In some cases, the twist tic or wire segments 17 can extend from a lateral side of a respective sidewall 11, 12 and be configured to be twisted or otherwise connected together to secure the sidewalls 11, 12 at a desired distance from each other. As will be understood, twisting of the wire segments 17 together can permit a user to draw the sidewalls 11, 12 together, e.g., as the wire segments 17 are further twisted together, the sidewalls 11, 12 may be pulled together and secured relative to each other. The twist tie or wire segments or other engagement features 17 can be attached to the sidewalls 11, 12 by adhesive, welding, etc. or may be formed integrally with the sidewall, e.g., cut from a same sheet of material used to form the sidewalls 11, 12. In some cases, the twist tie segments 17 can extend through openings 18 in the sidewalls 11, 12 as can be seen in FIG. 4 near the bottom of the food holder 1. Thus, the wire segments 17 can be threaded through one or more openings 18 of the sidewall 11, 12 to secure the segments 17 to the sidewall 11, 12.

In some embodiments, a food holder 1 can include first and second lateral end walls 15 extending between the first and second sidewalls 11, 12 at first and second lateral sides of the first and second sidewalls 11, 12 and/or a bottom wall 16 extending between the first and second sidewalls 11, 12 at a bottom side of the sidewalls 11, 12 and/or a top wall (not shown) extending between the sidewalls 11, 12 at a top side of the sidewalls 11, 12. The lateral end walls, top wall and/or the bottom wall can include pleats, e.g., one or more fold lines 19, that permit the lateral end walls 15, top wall and/or the bottom wall 16 to accommodate movement of the sidewalls 11, 12 towards each other. In some cases, the lateral end walls 15, top wall and/or the bottom wall 16 can fold or otherwise deform to permit movement of the sidewalls 11, 12 together while also enclosing the space where the food item is held, e.g., to resist exit of vapor and/or liquid from the space during a heating operation. In some cases, lateral end wall 15, top wall and/or bottom wall 16 portions may overlap to accommodate movement of the sidewalls 11, 12 together. This can permit the sidewalls 11, 12 to be pressed against or squeeze a food item while maintaining the bottom, top and/or lateral sides of the space in a suitably enclosed state, as well as accommodate a wide variety of different food items that have different thicknesses (i.e., a dimension corresponding to a distance between the sidewalls 11, 12). The pleat and/or overlap feature of the bottom wall 16, top wall and/or lateral end walls 15 can be employed with engagement features 17, and thus allow the engagement features 17 to be operated to pull the sidewalls 11, 12 together or otherwise secure the sidewalls 11, 12 relative to each other with a reduced distance between them. Fold lines 19 may be provided in any suitable location and/or in any suitable way. For example, fold lines 19 may be provided in a triangular fold arrangement near a bottom of the lateral end walls 15 to accommodate reduced distance between the sidewalls 11, 12 without providing substantial resistance to movement. Multiple fold lines 19 can be provided, e.g., in a bellows or accordion like arrangement in some cases. In some cases, fold lines 19 may be defined in advance, e.g., by scoring, thinned areas of the wall, or other, or may be formed in response to movement of the sidewalls 11, 12 toward each other, e.g., one or more portions of the end walls, top wall or bottom wall may crease as the sidewalls 11, 12 move together.

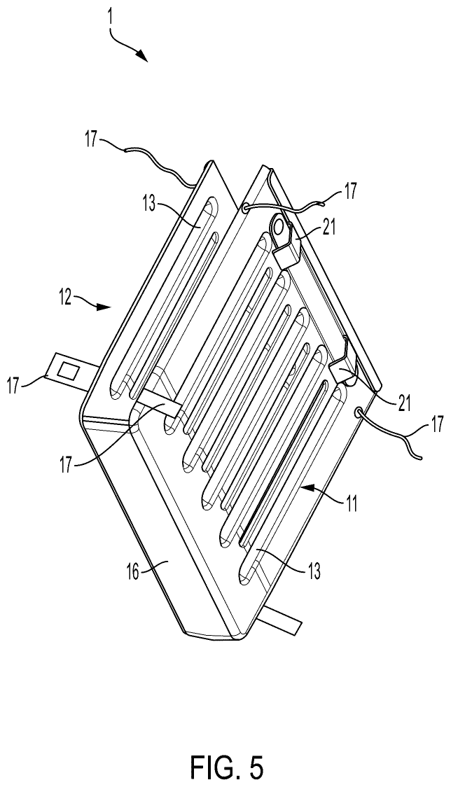

Although FIGS. 1-4 show arrangements of a food holder 1 having both lateral end walls 15 and a bottom wall 16, this is not required in all embodiments. For example, FIG. 5 shows an arrangement that includes no lateral end walls 15, i.e., the lateral sides of the food holder 1 are open. The FIG. 5 embodiment includes a bottom wall 16, which may include one or more fold lines 19 (or not) as shown. An arrangement like FIG. 5 may permit the sidewalls 11, 12 to be pivoted or otherwise moved apart to receive a food item between the sidewalls 11, 12. In some cases, the bottom wall 16 may be eliminated and the food holder 1 may include only sidewalls 11, 12, e.g., which are secured together by engagement features 17 at the lateral ends, top and/or bottom of the sidewalls 11, 12. Similarly, a bottom wall 16 may be eliminated in some cases, and the food holder 1 may include lateral end walls 15 only.

The sidewalls 11, 12 and/or lateral end walls 15 and/or bottom wall 16 and/or top wall may be made of any suitable material, such as a material that is thermally conductive, impermeable to liquids or vapor, or otherwise suitable for holding a food item during heating. In some cases, the sidewalls, end walls, top wall and/or bottom wall can be formed of an impermeable, unperforated sheet of material, such as a metal sheet (e.g., of aluminum, stainless steel or other) or a laminate material (e.g., including one or more metal layers coupled to one or more paper, cellulose or other thermally insulating layers). Outer and/or inner surfaces of the sidewalls 11, 12 and/or lateral end walls 15, top wall and/or bottom wall 16 may be painted, coated or otherwise have a dark color, such as a red or black color to absorb heat energy. Metal portions of the food holder may help transfer heat energy to a food item by conduction, while insulating portions may help reduce heat transfer to selected portions of a food item and/or provide a gripping area for a user and reduce the chance of burning. For example, the food holder 1 can include one or more handles 2 that extend from a top end of a sidewall 11, 12 (e.g., as shown in FIG. 1) and/or a lateral end wall 15 (e.g., as shown in FIG. 2). The handle(s) 2 may be positioned at any suitable location on the sidewalls 11, 12 and/or lateral end walls 15, e.g., two or more handles 2 may be equally spaced along one or both sidewalls. The handle 2 can be formed as a tag or flap that extends from one or more of the sidewalls 11, 12 and/or lateral end walls 15, or in other ways as discussed more herein. The handle(s) 2 can be configured to have a reflective or light colored surface, e.g., to help dissipate heat and make the handle(s) cooler to the touch. In some embodiments, the handles may be perforated, have insulating portions and/or other features to help make the handle(s) cooler to touch and allow handling of the food holder while the holder is hot. In some cases, the handle(s) 2 may additionally operate as a stop to help prevent the food holder 1 from entering into a cooking cavity of a toaster beyond a particular distance, e.g., the handle 2 or other stop may contact a portion of the toaster adjacent a food slot to prevent further movement of the food holder 1 into the toaster. FIGS. 4 and 5 show an embodiment in which a guide or stop 21 is configured on the top end of the first and second sidewalls 11, 12. The guide or stop 21 can be arranged in different ways, and in FIGS. 4 and 5 the guide or stop 21 is arranged as a portion of the sidewall 11, 12 or a component attached to the sidewall 11, 12 that has a triangular shape when viewed from the side as in FIG. 4. That is, the guide or stop 21 has a lower portion that extends upwardly and outwardly, away from the space in which the food item is held, and an upper portion that extends upwardly and inwardly (e.g., toward the top edge of the sidewall 11, 12). This configuration can permit the lower portion to contact a portion or a toaster or other cooking cavity to help guide the holder 1 to a centered or other position in the cooking cavity. That is, as a user lowers the holder 1 into the cooking cavity, the lower portion of the guides 21 may contact an edge of the opening to the cavity and help move the holder 1 to a centered position in the cavity and/or stop movement of the holder 1 into the cavity (e.g., when a distance between the portions of the guides 21 contacting the edge defining the cavity opening is wider than the opening itself). The guides or stops 21 may have other shapes or arrangements, such as horizontal walls or flaps that extend outwardly from the sidewalls 11, 12 and others.

In some cases, the sheet of material and/or the shape of the sheet of material (e.g., a moment of inertial of the sidewall including ridges 13 or other shapes) may make the sidewalls 11, 12 relatively rigid such that the sidewalls 11, 12 remain planar even when the sidewalls 11, 12 are operated to compress a food item, e.g., in response to securing by the engagement features 17 and/or a user pressing the sidewalls 11, 12 toward each other. This may help ridges 13 or other features of the sidewalls 11, 12 to press against the food item and improve conductive heat transfer and/or help uniformly compress the food item. Although rigid, the sidewalls 11, 12 may be made of relatively thin and lightweight material, e.g., such that the food holder 1 is suitable for single use in heating a food item. This may permit a food holder 1 to be sold in assembled form with a food item, e.g., in a vacuum packed bag or other container, that can be removed from the outer container and placed in a toaster.

As can be seen in FIG. 3, one or both of the sidewalls 11, 12 can have a plurality of ridges 13 that extend inwardly from an inner side of the sidewall into the space where the food item is located. For example, the first and second sidewalls 11, 12 in FIGS. 1 and 2 have ridges 13 that extend along the inner surface of the sidewalls 11, 12 in a direction from the top to the bottom of the sidewalls 11, 12 and may have a width in a direction from one lateral side to the other of the sidewalls 11, 12. Openings 14 can be provided in the sidewalls 11, 12, e.g., between adjacent ridges 13 and extend in a same direction as the ridges 13. For example, the openings 14 can be arranged as elongated slots formed in the sidewalls 11, 12 that extend between adjacent ridges 13. As described above, the ridges 13 and/or openings 14 can be sized and/or shaped to provide desired heat transfer, venting and/or other features. For example, the openings 14 can be the only voids or holes in the sidewalls 11, 12 and can be arranged so that the sidewalls 11, 12 have a ratio of an open area to closed or total surface area of 40% or less, e.g., 30% or less, or 20% or less, or 10% or less. The ridges 13 can be formed by concave depressions in the outer surface of the sidewalls 11, 12 and convex portions at the inner surface of the sidewalls 11, 12. The concave/convex features can have any suitable shape, such as semi-circular, elliptical, or other in cross section. The concave depression/convex portion of each ridge 13 can be larger (in surface area, width and/or length) than any one of the openings 14. The ridges 13 and/or openings 14 can extend along 60% or more of the sidewalls 11, 12, e.g., can extend vertically on the sidewalls 11, 12 along a length that is 60%, 70%, 80% or more of a vertical height of the sidewalls 11, 12. The ridges 13 can each extend horizontally along a substantial portion of the entire width of the sidewall 11, 12, e.g., 2%, 5%, 2-10%, 15%, 20% or more of the width of the sidewall. The ridges 13 can form a substantial portion of each sidewall 11, 12, e.g., up to 50%, up to 40%, up to 30% or up to 20% of the surface area of a sidewall 11, 12.

Vertical extension of ridges 13 along the sidewalls 11, 12 can be useful when the holder 1 is used with a cooking cavity 104 that has heating elements 108 that also extend vertically. In some embodiments, the ridges 13 on the holder 1 can be positioned, sized, shaped or otherwise arranged to operate with a corresponding heating element 108 of a cooking cavity 104. For example, each ridge 13 can extend in a same direction and location as a corresponding heating element 108. This can allow the heating element 108 to provide heat more directly to the corresponding ridge 13, which can improve the food item heating process. This configuration can also allow a heating element 108 to move into at least a portion of a concave area defined by a ridge 13, e.g., due to thermal expansion of the heating element 108 during a cooking process. While heating elements 108 and ridges 13 are said to extend vertically in some embodiments, ridges on a holder can extend in any suitable way which may correspond to a way in which heating elements extend in a cooking cavity that receives the holder. For example, ridges can extend diagonally, horizontally and/or otherwise be configured to operate with a corresponding heating element. Of course, ridges or other similar features at an inner surface of the sidewalls is not required for all embodiments.

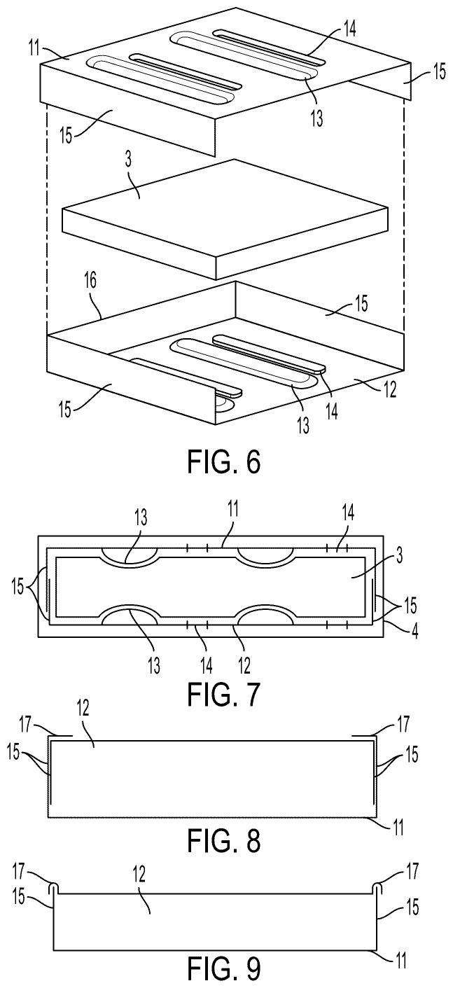

As noted above, some embodiments may include lateral end walls, top walls and/or bottom walls that are configured in various ways other than those shown in FIGS. 1-5. For example, while the embodiments of FIGS. 1-5 may have both sidewalls formed as a single unitary piece, e.g., stamped from a sheet of metal foil or other laminate sheet, in some embodiments (including those of FIGS. 1-5), the sidewalls 11, 12 may be formed as separate pieces or parts that are joined together. Embodiments in which the sidewalls 11, 12 and/or other portions of the food holder are formed as separate parts may have the separate parts attached to each other, e.g., by crimping, adhesive, welding, engagement features, etc., or the separate parts need not be attached to each other. Instead, the separate parts may be held in relation to a food item by a toaster or other cooking appliance, e.g., that presses on an outer surface of the sidewalls, by engagement with a food item, or other. FIG. 6 shows an embodiment in which first and second sidewalls 11, 12 are formed as separate parts and assembled together with a food item 3 that is positioned in a space between the sidewalls 11, 12. The food item 3 may include any suitable edible component or components, such as bread, meat, cheese, condiments, and/or any other edible item. In some embodiments, lateral end wall portions 15 and/or bottom wall portions 16 may extend from lateral ends and/or the bottom end of the sidewalls 11, 12 (or not, as described above). (A top wall may be provided for one or both sidewalls, although not shown in FIG. 6.) In some cases, portions of one of the sidewalls, lateral end walls, top wall and/or bottom wall may be received into a channel or other cavity defined by the other sidewall, lateral end walls, top wall and/or bottom wall. For example, the first sidewall 11 and its corresponding lateral end wall portions 15 and bottom wall portion 16 may define a cavity such as a groove or channel in which parts of the second sidewall 12 and/or its corresponding lateral end wall portions 15 and/or bottom wall portion 16 are received. Thus, for example, a food item 3 can be placed in a cavity defined by the second sidewall 12 and its lateral end walls, top wall and/or bottom wall, and then the first sidewall 11 positioned to receive at least parts of the food item 3 and the second sidewall 12 and its lateral end walls, top wall or bottom wall in a cavity defined by the first sidewall 11 and its lateral end walls or bottom wall. Such an arrangement can be seen, for example, in FIG. 7 which shows parts of the lateral end walls 15 of the second sidewall 12 and the food item 3 received into a cavity defined by the first sidewall 11 and its lateral end walls 15. In FIG. 7, the first sidewall 11 and its lateral end walls 15 define a U-shaped channel in which at least portion of the lateral end walls attached to the second sidewall 12 and/or portions of the second sidewall 12 are received. Parts of the top wall or bottom wall portions 16 of the second sidewall 12 may be similarly received into a cavity defined by the first sidewall 11 and its top wall or bottom wall 16. In some cases, the lateral end wall portion 15, top wall and/or the bottom wall portions 16 of the first and second sidewalls 11, 12 may overlap each other, e.g., as shown in FIG. 7. In some embodiments, the first and second lateral end walls 15 may be arranged to enclose the space in which the food item 3 is received and resist movement of materials from the food item, such as grease, oils, liquids, water vapor, etc., out of the space. In some cases, overlapping portions of the first and second lateral end walls 15 may be configured to enclose the space and resist movement of materials from the food item out of the space through a pathway between the overlapping portions. For example, the overlapping portions may be closely spaced from each other, e.g., in contact or crimped or adhered, to help resist passage of materials through an interface between the wall portions. In some cases, a majority of a width of the first and/or second lateral end walls 15, top walls and/or the bottom walls 16 may overlap with each other, e.g., as can be seen in FIG. 7. For example, at least one lateral end wall portion may completely overlap with a corresponding lateral end wall portion attached to the opposite sidewall, e.g., an entire width of each of the corresponding lateral end walls may overlap with each other. Overlapping portions of the lateral end walls, top walls and/or bottom walls may be attached to each other, e.g., using one or more engagement features such as tabs, twist wires, crimping of the wall portions together, welding, adhesive, etc. Such engagement may help resist passage of materials such as liquid or vapor out of the space, e.g., via an interface between the lateral end walls.

In some embodiments, engagement features may engage the lateral end walls, top walls and/or bottom walls to resist movement of the sidewalls away from each other. For example, the food holder 1 in FIGS. 6 and 7 can include any engagement features described herein, e.g., including those employed in FIGS. 1-5. Other arrangements are possible for engagement features, however. In some embodiments, portions of lateral end walls for a sidewall may extend over corresponding portions of the opposing sidewall, e.g., at the lateral sides of the opposing sidewall. For example, FIG. 8 shows an arrangement in which portions of the lateral end walls 15 attached to the first sidewall 11 extend over corresponding portions of the second sidewall 12 at the first and second lateral sides of the second sidewall 12. The lateral end walls 15 may be configured to engage with the second sidewall 12 to resist movement of the second sidewall 12 away from the first sidewall 11. For example, a food item may be held compressed between the first and second sidewalls 11, 12 based on the engagement of the lateral end walls 15 engaging with the lateral sides of the second sidewall 12. The lateral end walls 15 may be folded or otherwise engaged over portions of the second sidewall 12 by placing the food item 3 between the sidewalls 11, 12, compressing the food item between the sidewalls, and folding portions of the lateral end walls 15 (and/or portions of the bottom wall 16) over corresponding portions of the second sidewall 12, e.g., so distal portions of the lateral end walls extend inwardly toward each other and over a portion of the second sidewall. Also, as can be seen in FIG. 8, the lateral end walls 15 attached to the second sidewall 12 may overlap with the lateral end walls 15 of the first sidewall 11 along their entire width (i.e., a direction from one sidewall to the other). FIG. 9 shows another embodiment for engagement features which can secure the first and second sidewalls relative to each other. In some embodiments such as that in FIG. 9, an engagement feature 17 can include a crimp connection between portions of the food holder, such as portions of the first and second sidewalls 11, 12, portions of lateral end walls 15, and/or portions of a bottom wall. For example, in FIG. 9 the second sidewall 12 has an engagement feature 17 at lateral sides that includes a U-shaped bend configured to receive a distal end portion of a lateral end wall 15. With the distal end portion of the lateral end wall 15 received into the U-shaped bend, the U-shaped bend can be crimped to capture or otherwise engage with the received lateral end wall portion. Such crimping can, in some arrangements, create a fluid-tight seal. A crimp-type engagement feature 17 can be provided along the entire lateral sides, top and bottom of the second sidewall 12, e.g., to provide a liquid tight seal between the first and second sidewalls 11, 12. Although the crimp-type engagement feature 17 is shown as having a portion formed at lateral, top and/or bottom edges of the second sidewall 12, such an engagement feature 17 can be provided in any suitable location, such as at lateral, top and/or bottom edges of the first sidewall 11 in addition or instead of at the edges of the second sidewall 12, at portions of the lateral end walls 15 and/or at portions of the top or bottom wall 16. For example, lateral end wall portions, top wall portions and/or bottom wall portions can be joined together at a crimp-type engagement feature, e.g., in an area equidistant from the first and second sidewalls 11, 12. Such engagement features may be configured to be disengaged by hand and without tools, e.g., by bending a crimped portion with thumb and forefinger to remove a food item from the food holder.

Although not necessarily shown in the embodiments of FIGS. 6-9, such embodiments can include any features described herein, at least to the extent not mutually exclusive of features shown. For example, the food holder in FIGS. 6-9 can include ridges with inner convex and outer concave shapes (or not), slot or other openings in the sidewalls, lateral end walls (or not and/or including pleats or not), a bottom wall (or not and/or including pleats or not), various types of engagement features 17 (e.g., to define a distance between the sidewalls), one or more guides or stops 21, and so on.

In some embodiments, a food product can be provided, e.g., in frozen or refrigerated form and ready to be inserted into a toaster or other cooking device for heating. This may allow a user to easily enjoy a properly toasted or otherwise heated sandwich or other food item with minimal knowledge or experience in operating a food holder. For example, in some cases a food product, e.g., for use in a toaster, may include a food holder with first and second sidewalls that are spaced apart from each other and define a space between the sidewalls. The sidewalls may be configured in any suitable way described herein for a food holder, e.g., having inner convex features formed by ridges on the sidewall, slots or other openings in the sidewall, etc. The sidewalls may be inedible, e.g., formed of a metal foil or other laminate. That is, the sidewalls may be food safe and theoretically could be ingested by a human, but are not intended to be eaten. An edible food item, such as a sandwich or other, may be positioned in the space between the first and second sidewalls, e.g., as shown in FIGS. 6 and 7. An overwrap 4, e.g., as shown in FIG. 7, may enclose the first and second sidewalls and the food item, e.g., to help protect the food item from an external environment, e.g., air, moisture, liquids, etc. The sidewalls and food item may be enclosed in an airtight enclosed space by the overwrap, e.g., the overwrap may include a bag, box, film or other covering that resists entry of air, moisture or other environmental conditions into the enclosed space in which the food item and sidewalls are held. In some cases, the overwrap 4 may be inedible, e.g., include a food safe film that covers the sidewalls and food item. The first and second sidewalls may be configured for use in heating the food item in the toaster or other cooking appliance and the overwrap may be configured to require removal of the overwrap from the first and second sidewalls and the food item prior to heating the food item in the toaster. Thus, a user may purchase or otherwise obtain the food product, e.g., from a freezer or refrigerator, and then remove the overwrap and insert the food holder and food item directly into a toaster or other cooking appliance. This may make preparation of a quality sandwich or other food item easy for the user while providing optimum results in terms of heating, caramelization, grilling or whatever cooking effects are desired to be provided by the food holder. Moreover, the food holder may be customized to the food item it is used with. After heating, the food holder, e.g., including the sidewalls, may be removed from the food item for eating of the food item. In some cases, the food holder may be configured for a single use, or may be capable of being recycled, e.g., cleaned and used again with another food item.

In some cases, a method of forming a food product configured for heating with a toaster, e.g., having a vertical cavity to receive and heat the food product and a plurality of heating elements associated with the vertical cavity, may include providing an edible food item in a space between first and second sidewalls of a food holder. The food item may include any suitable components, such as that commonly found in sandwiches or other foods. The food holder may include first and second sidewalls, e.g., having any combination of features described herein, and may be inedible, e.g., formed from a metal foil or other laminate. The first and second sidewalls and the food item may be enclosed by an overwrap, e.g., enclosed in an airtight enclosed space defined by the overwrap, such as a metal or polymer film, bag, box, etc. The overwrap may be inedible, e.g., formed of one or more of a polymer, metal or combination of materials such as is found in food packaging. In some cases, the first and second sidewalls may be compressed into contact with the food item, either before being covered by the overwrap or after being covered by the overwrap. For example, the food item and sidewalls may be assembled together and the sidewalls moved toward each other to suitably compress or squeeze the food item between the sidewalls. Thereafter, the overwrap may be provided over the food item and sidewalls, e.g., so the overwrap holds the sidewalls at a desired distance from each other during storage. In some cases, one or more engagement features instead of, or in addition to, the overwrap may be employed to help keep the sidewalls at a desired distance from each other. In some embodiments, the overwrap may be used to move the sidewalls toward each other and compress the food item. For example, a vacuum or relatively low pressure may be provided in the enclosure provided by the overwrap, which may cause atmospheric pressure to press on the overwrap and the sidewalls to compress the food item. With a suitably low pressure established in the enclosure provided by the overwrap, the overwrap may be sealed to maintain a pressing force on the sidewalls. In some embodiments, the overwrap may itself generate a pressing force on the sidewalls, e.g., the overwrap may include a heat shrink film or other arrangement that reduces in length or surface area such as when exposed to heat or other energy. A size reduction of the overwrap may exert a force on the sidewalls to move the sidewalls towards each other and compress the food item.

In some cases, the first and second sidewalls may be moved toward each other so as to deform the food item in the space between the sidewalls in response to contact with the first and second sidewalls. For example, the sidewalls may include ridges that form convex features at the inner surface of the sidewalls that extend into the space, although such ridges are not required. The ridges may act to deform a corresponding portion of the food item, e.g., so that concave depressions are formed in the food item as shown in FIG. 7. This may increase a surface area for transferring conductive heat from the sidewalls to the food item. In addition, or alternately, the sidewalls may define flowpaths for gas or other material emitted by the food item during heating to flow (or may be entirely impermeable). Such flowpaths may be adjacent ridges or other convex features at the inner side of the sidewalls, e.g., at the base of the convex features adjacent a planar portion of the sidewall. The flowpaths may allow vapor or other materials to flow to one of the openings that may extend through the first and second sidewalls. FIG. 7 shows such flowpaths between the food item 3 and the sidewalls 11, 12 in areas between the ridges 13 and the openings 14. As an example, the flowpaths may permit steam emitted by the food item to flow in a flowpath between the food item and the sidewall to exit via an opening 14.

With the food item and food holder assembled and contained in an overwrap, the entire food product may be frozen, refrigerated or otherwise stored for later use. A user may be instructed to remove the overwrap prior to heating, and to insert the assembled food holder (e.g., including sidewalls, lateral end walls, top wall and/or bottom wall) into a toaster or other cooking device for heating. The user may be instructed to remove the sidewalls and other portions of the food holder from the food item after heating prior to consumption.

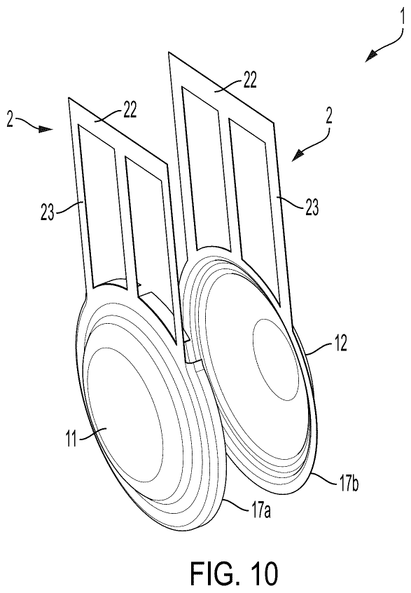

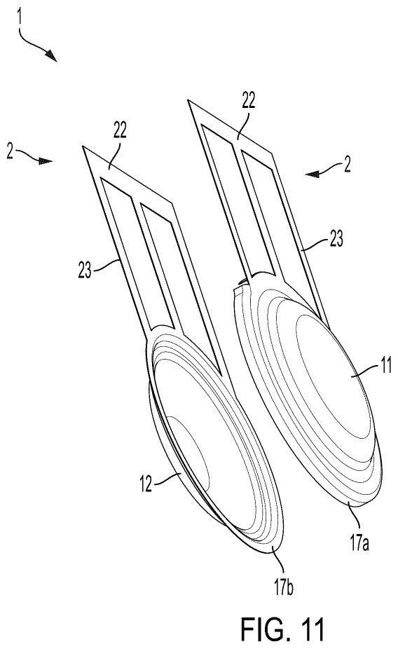

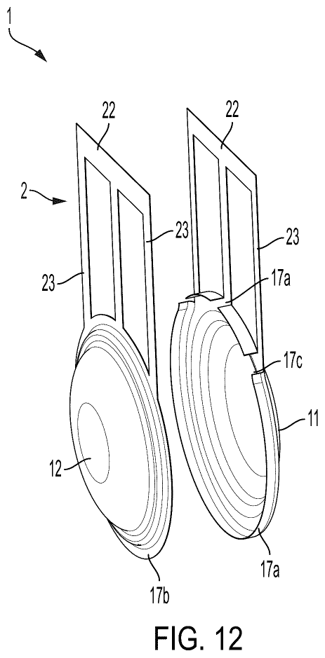

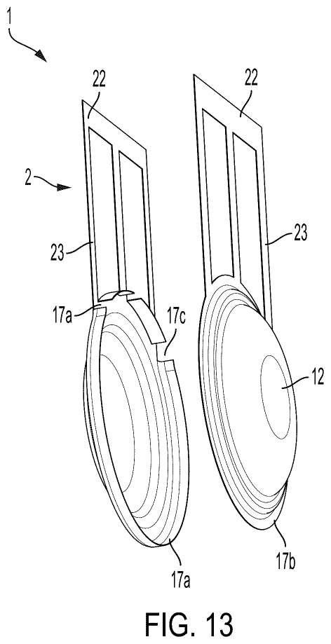

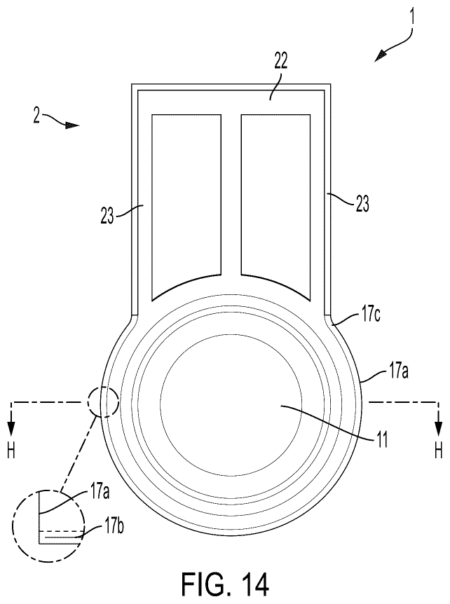

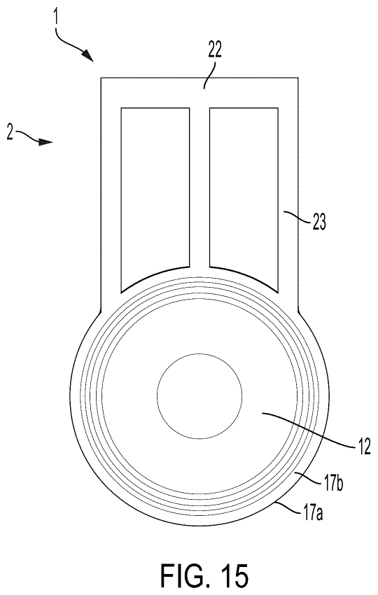

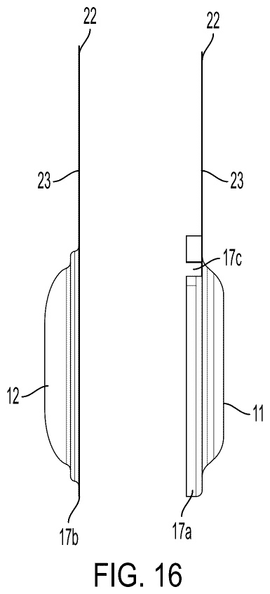

FIGS. 10-18 illustrate embodiments that incorporate features described above and/or other features that may be included with a food holder 1. In some embodiments, as in those discussed above, a food holder 1 may include first and second sidewalls 11, 12 that are spaced apart from each other and define a space between the sidewalls to receive a food item. For example, FIGS. 10-17 show an arrangement in which first and second sidewalls 11, 12 include a convex outer side and a concave inner side. The first and second sidewalls 11, 12 can be assembled together so that the concave inner sides of the sidewalls 11, 12 define an inner space for the food item. In some embodiments, the inner space may have a lens-type shape with a generally smoothly curved concave sides, although any suitable shape may be employed, such as a rectangular box-like shape and others. In some embodiments, one or both sidewalls 11, 12 may be entirely unperforated, e.g., be formed of a sheet of unperforated metal or other material. In some cases, the sidewalls 11, 12 may prevent or otherwise resist exit of steam or other materials from the inner space, e.g., so that the food item loses little or no moisture during heating. In some cases, the sidewalls 11, 12 may have one or more engagement features at a periphery of the first and second sidewalls, and in some cases the engagement features may be configured to be manipulated by hand to secure the first and second sidewalls to each other and/or to disconnect the first and second sidewalls from each other to remove the food item from the space. Thus, the sidewalls 11, 12 in FIGS. 10-17 may include suitable engagement features 17 like those described above or otherwise herein. In some cases, the engagement features 17 may include a manually manipulable, plastically deformable element to secure a portion of the first and second sidewalls together. For example, the engagement features 17 may include at least one twist tie and/or complementary sets of first and second tabs extending from the first and/or second sidewall as discussed above. The engagement features 17 may have any suitable features discussed herein, such as being operable to pull the first and second sidewalls towards each other and reduce the distance between the first and second sidewalls. In some cases, the engagement features may include a first flange 17a on the periphery of the first sidewall 11 and a second flange 17b on the periphery of the second sidewall 12. The first and second flanges 17a, 17b may be configured to engage with each other, e.g., to secure the first and second sidewalls 11, 12 to each other and hold the food item in the space between the sidewalls 11, 12. For example, in some cases the first flange 17a may be configured to receive and be plastically deformed around a portion of the second flange 17b to secure the first and second sidewalls 11, 12 together. For example, as can be seen in FIGS. 10-13, the first flange 17a may have an annular shape with an L shaped cross section (e.g., in cross section perpendicular to a plane of the sidewall 11) and the second flange 17b may have a flat annular shape. The first flange 17a may have first portion that defines a cylindrical shape or wall, e.g., that extends in a direction toward the second sidewall 12 as can be seen in FIGS. 10-13, and a second portion that has a flat annular shape that extends radially outwardly from the outer periphery of the first sidewall 11. Thus, together the first and second portions of the first flange 17a may have an L shape in a horizontal cross section H-H in FIG. 14. The second flange 17b may be received by the first flange 17a, e.g., so that the second portion of the first flange 17a contacts the flat annular shape of the second flange 17b and the second flange 17b is received into a cylindrical space defined by the first portion of the first flange 17a. The first flange 17a can be plastically deformed around the second flange 17b, e.g., as shown by the dashed line position of the first portion of the first flange 17a seen in the bubble view of FIG. 14, so that the second flange 17b is trapped or otherwise held between the first and second portions of the first flange 17a. For example, the first flange 17a may be bent at the junction between the first and second portions so as to form a 180 degree bend and the first and second portions lie in parallel planes on opposite sides of the second flange 17b. Such bending can be seen in FIG. 9 where a portion of the second sidewall 12 is bent to form a 180 degree bend that extends around a portion of the end wall 15 so that first and second portions of the second sidewall 12 lie in parallel planes on opposite sides of the portion of the end wall 15. This may suitably engage the sidewalls 11, 12 together. Plastic deformation of the first flange 17a to engage the sidewalls 11, 12 together may be done by hand and without tools, e.g., by bending the first flange 17a using thumb and forefinger. In addition, or alternately, disengagement of the first and second flanges 17a, 17b may be done by hand and without tools, e.g., by bending the first portion of the first flange 17a so that the second flange 17b is released and the first and second sidewalls 11, 12 can be separated from each other to remove the food item from the space between the sidewalls 11, 12. In some cases, the engagement features 17 can be configured to permit plastic deformation to engage and disengage the sidewalls 11, 12 multiple times, e.g., to permit the sidewalls 11, 12 to be used multiple times to heat different food items. As seen in FIGS. 10-15, the peripheries of the first and second sidewalls 11, 12 may have circular shape, although other shapes can be used such as triangular, rectangular and others.

In some embodiments, one or both sidewalls 11, 12 may have a handle attached to the sidewall, e.g., for manipulating the sidewall and an attached other sidewall and food item for placement into and removal from a toaster or other cooking device. For example, a handle 2 may be attached to the first and/or second sidewall 11, 12 and the handle 2 may be configured to support the first and second sidewalls for positioning the first and second sidewalls and the food item in a vertical cavity of a toaster and for removing the first and second sidewalls and the food item from the vertical cavity. As can be seen in FIGS. 10-15, one or more legs 23 of a handle 2 may extend from a sidewall 11, 12 to a grip portion 22. The embodiments in FIGS. 10-18 include three legs 23 for each handle 2, but one or any other number of suitable legs 23 may be used. Also, both sidewalls 11, 12 include a handle 2 in FIGS. 10-18, but only one sidewall 11 or 12 may have a handle 2. Note that handle features can be used with any suitable food holder 1 having any suitable features, such as a food holder 1 with or without engagement features 17 and other features described herein. For example, a handle like that in FIGS. 10-18 can be used with any of the embodiments of FIGS. 1-9.

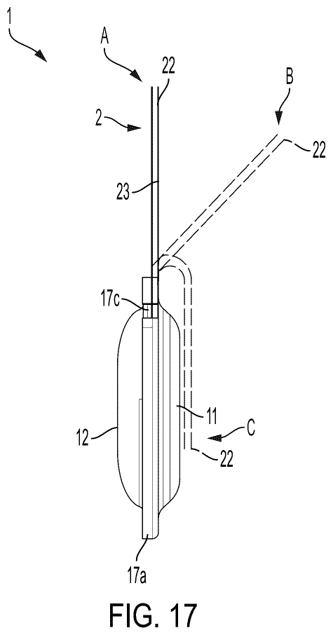

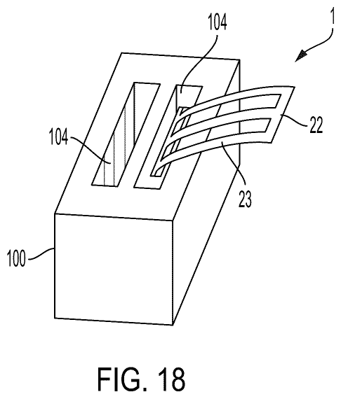

In some cases, a handle 2 may include a grip portion 22 that is movable relative to the sidewall 11, 12 to which the handle 2 is attached. For example, a handle 2 may be configured for positioning the grip portion 22 adjacent a sidewall 11, 12 and away from the sidewall 11, 12. FIG. 17 shows one example of a handle 2 which has a grip portion 22 that can be moved relative to a sidewall 11, 12 to which the handle 2 is attached. A handle 2 may initially be in a position A, e.g., if the handle 2 is formed integrally with a sidewall 11, 12 such as by die cutting, stamping or otherwise forming the handle 2 from a sheet of material with the sidewall 11, 12, the handle 2 may be arranged in a plane that is generally parallel with a plane of the sidewall 11, 12. The grip portion 22 may be moved to a position C in which the grip portion 22 is adjacent a sidewall 11, e.g., by plastically deforming a portion of the handle 2. Thus, for example, a user may bend a portion of the handle 2 (e.g., a leg 23) so the grip portion 22 is at position C and the grip portion 22 may remain at position C when the user releases the handle 2. It will be understood that the handle 2 may be manipulated in a variety of ways, e.g., so that the grip portion 22 is located in any suitable position relative to the sidewalls 11, 12. For example, the grip portion 22 may be moved to a position B that can be useful for placing the food item and sidewalls 11, 12 into a vertical cavity of a toaster, for heating the food item in the toaster, and/or for removing the food item and sidewalls 11, 12 from the toaster. The position B can be a position in which the grip portion 22 is in a location that is between lateral ends of the first and second sidewalls 11, 12, above top ends of the first and second sidewalls 11, 12, and offset from planes of the first and second sidewalls 11, 12 such that a plane of one sidewall, e.g., the first sidewall 11, is between a plane of the other sidewall, e.g., the second sidewall 12, and the grip portion 22. This configuration can be seen in FIG. 18 where the grip portion 22 is located offset from the vertical cavity 104 of the toaster 100 (e.g., offset in a horizontal direction), is located between the lateral ends of the sidewalls 11, 12 and is above a top of the sidewalls 11, 12. (Reference to top, lateral sides and bottom ends or parts of the sidewalls 11, 12 refers to the orientation of the sidewalls 11, 12 when placed in a vertical cavity of a toaster 100, and applies equally to sidewalls 11, 12 having a circular, oval or other shape as well as a rectangular shape.) This location may allow a user to easily grasp the grip portion 22 to manipulate the food item and sidewalls 11, 12, e.g., because the grip portion 22 may not be heated excessively by heat exiting the vertical cavity 104 of the toaster 100. Also, in some cases a user may position the grip portion 22 in any desired location, e.g., by plastically deforming a portion of the handle 2, and the grip portion 22 will remain in the desired location. In some cases, a part of the handle may be plastically deformable to permit movement of the grip portion 22 between the two or more positions relative to the sidewalls 11, 12 multiple times, e.g., to allow a user to move the grip portion 22 multiple times to different positions. In some cases, features of a handle 2 and engagement features 17 may be arranged to cooperate with each other. For example, as can be seen in FIGS. 10, 12, 13 and 17, the first flange 17a of the first sidewall 11 may include notches 17c in the first portion of the first flange 17a to permit portions of the legs 23 to extend upwardly and away from the sidewalls 11, 12 and to avoid interference with engagement of the first flange 17a with the second flange 17b.

Use of a food holder to heat a food item in a vertical cavity of a toaster (or other cooking device) can include providing a food item in a space between first and second sidewalls of the food holder. The first and second sidewalls can be configured in any suitable way having any feature or combination of features described herein or otherwise. For example, the first and second sidewalls may be completely unperforated, e.g., having no openings at all, or may have openings to permit steam or other fluid to escape the space where the food item is held. A grip portion of a handle attached to the first and/or second sidewall may be moved from a first position to a second position relative to the first and/or second sidewall. For example, the food holder may be purchased from a grocery store or other supplier having a food item secured within a space between first and second sidewalls that are secured together, e.g., by engagement features of the sidewalls. The handle may be provided in a storage position, e.g., like position C in FIG. 17 so that the food holder 1 can have a relatively small size during shipment and storage. The food holder 1 with folded handle 2 may be removed from an overwrap or other packaging, and a user may move the grip portion from a storage position, e.g., like position C in FIG. 17, to another position away from the sidewalls 11, 12 such as position A or B in FIG. 17 so the user can manipulate the food holder 1. This movement may be achieved by plastically deforming a portion of the handle 2 or in other ways, such as by moving a hinged portion of the handle 2. The grip portion of the handle may be manipulated to position the food item and the first and second sidewalls 11, 12 in the vertical cavity or other cooking cavity of the cooking device to heat the food item. As an example, the user may grasp the grip portion 22 and lower the food item and sidewalls 11, 12 into a toaster cavity. The grip portion may be positioned in a location that is between lateral ends of the first and second sidewalls 11, 12 and offset from planes of the first and second sidewalls 11, 12 such that a plane of one sidewall is between a plane of the other sidewall and the grip portion. The grip portion 22 may be positioned above a top of the sidewalls 11, 12. After heating the food item, the food item may be removed from the vertical cavity or other cooking cavity, e.g., by grasping the grip portion which is located at a position offset from the vertical cavity of the toaster and lifting the food item. The food item may be removed from the sidewalls 11, 12, e.g., by disengaging engagement features that secure the sidewalls together by hand and without tools to remove the food item from the space.

In some embodiments, a method for using a food holder can include providing a food item in a space between first and second sidewalls, where the first and second sidewalls are secured to each other by engagement features at a periphery of the first and second sidewalls, e.g., at top, bottom and/or sides of the sidewalls. For example, the engagement features may include a manually manipulable, plastically deformable element to secure a portion of the first and second sidewalls together. The method can include positioning the food item and the first and second sidewalls in the vertical cavity to heat the food item, removing the food item from the vertical cavity after heating the food item, and disengaging the plastically deformable element by hand and without tools to remove the food item from the space. For example, disengaging the plastically deformable element may include disengaging at least one twist tie extending from the first sidewall, disengaging complementary sets of first and second tabs from each other, where the first tabs extending from the first sidewall and the second tabs extending from the second sidewall, disengaging the first and second sidewalls from each other to permit the first and second sidewalls to be moved away from each other, disengaging a first flange on the periphery of the first sidewall from a second flange on the periphery of the second sidewall where the first flange is plastically deformed around a portion of the second flange to secure the first and second sidewalls together, disengaging a clamp element that is separate from the sidewalls and is bent to engage portions of the sidewalls to hold the sidewalls together, and others. The peripheries of the first and second sidewalls may have a circular shape, a rectangular shape, or others.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A food holder configured for use with a toaster having a vertical cavity to receive and heat a food item and a plurality of heating elements associated with the vertical cavity, the food holder comprising:
first and second sidewalls having portions spaced apart from each other to define a space between the sidewalls to receive the food item; and
engagement features at a periphery of the first and second sidewalls configured to be manipulated by hand to secure the first and second sidewalls to each other and disconnect the first and second sidewalls from each other to remove the food item from the space, the engagement features including a manually manipulable, plastically deformable element to secure a portion of the first and second sidewalls together,
wherein the first and second sidewalls secured together by the engagement features are configured for insertion into the vertical cavity to heat the food item in the space between the first and second sidewalls.

2. The food holder of claim 1, wherein the engagement features include at least one twist tie extending from the first sidewall to the second sidewall.

3. The food holder of claim 1, wherein the engagement features include complementary sets of first and second tabs, the first tabs extending from the first sidewall and the second tabs extending from the second sidewall, the first and second tabs of each complementary set configured to engage with each other to define, at least in part, a distance between the first and second sidewalls.

4. The food holder of claim 1, wherein the engagement features are operable to pull the first and second sidewalls towards each other and reduce the distance between the first and second sidewalls.

5. The food holder of claim 1, wherein the space is completely enclosed by the first and second sidewalls with the engagement features engaged with each other.

6. The food holder of claim 1, wherein the engagement features include a first flange on the periphery of the first sidewall and a second flange on the periphery of the second sidewall, wherein the first flange is configured to receive and be plastically deformed around a portion of the second flange to secure the first and second sidewalls together.

7. The food holder of claim 6, wherein the first flange has an annular shape with an L shaped cross section and the second flange has a flat annular shape.

8. The food holder of claim 6, wherein the peripheries of the first and second sidewalls have a circular shape.

9. The food holder of claim 6, wherein the peripheries of the first and second sidewalls have a rectangular shape.

10. The food holder of claim 1, wherein the first and second sidewalls are completely unperforated.

11. The food holder of claim 1, wherein the engagement features are configured to engage with each other to define a distance between the first and second sidewalls.

12. The food holder of claim 1, wherein the engagement features include a plastically deformable portion of the sidewall configured to be plastically deformed by hand and without tools.

13. The food holder of claim 1, wherein the manually manipulable, plastically deformable element is configured to be moved by hand between an engaged position and a disengaged position a plurality of times.

14. The food holder of claim 1, further comprising a handle attached to the first sidewall, the handle configured to support the first and second sidewalls for positioning the first and second sidewalls and the food item in the vertical cavity and for removing the first and second sidewalls and the food item from the vertical cavity.

15. The food holder of claim 14, wherein the handle includes a grip portion that is movable relative to the first sidewall.

16. The food holder of claim 15, wherein the handle is configured for positioning the grip portion adjacent the first sidewall and away from the first sidewall.

17. The food holder of claim 15, wherein the grip portion is positionable in a location that is between lateral ends of the first and second sidewalls, above top ends of the first and second sidewalls, and offset from planes of the first and second sidewalls such that a plane of the first sidewall is between a plane of the second sidewall and the grip portion.

18. The food holder of claim 15, wherein a part of the handle is plastically deformable to permit movement of the grip portion relative to the first sidewall.

19. The food holder of claim 1, wherein the first and second sidewalls are formed of an unperforated and/or impervious metal sheet material and include a concave inner surface to define the space.

20. The food holder of claim 1, further comprising:
the food item positioned in the space, wherein the engagement features are engaged to position the peripheries of the first and second sidewalls adjacent each other and enclose the food item in the space, and
a handle attached to the first sidewall, the handle configured to support the first and second sidewalls for positioning the first and second sidewalls and the food item in the vertical cavity and for removing the first and second sidewalls and the food item from the vertical cavity, the handle having a grip portion that is movable toward and away from the first sidewall.

21. A method for using a food holder configured for use with a toaster having a vertical cavity to receive and heat a food item and a plurality of heating elements associated with the vertical cavity, the method comprising:
providing a food item in a space between first and second sidewalls, the first and second sidewalls secured to each other by engagement features at a periphery of the first and second sidewalls, the engagement features including a manually manipulable, plastically deformable element to secure a portion of the first and second sidewalls together;
positioning the food item and the first and second sidewalls in the vertical cavity to heat the food item;
removing the food item from the vertical cavity after heating the food item; and
disengaging the plastically deformable element by hand and without tools to remove the food item from the space.

22.-35. (canceled)

36. A food holder configured for use with a toaster having a vertical cavity to receive and heat a food item and a plurality of heating elements associated with the vertical cavity, the food holder comprising:
first and second sidewalls configured to define a space between the sidewalls to receive and hold the food item; and
a handle attached to the first sidewall, the handle configured to support the first and second sidewalls for positioning the first and second sidewalls and the food item in the vertical cavity and for removing the first and second sidewalls and the food item from the vertical cavity, the handle including a grip portion that is movable relative to the first sidewall,
wherein the first and second sidewalls are configured for insertion into the vertical cavity to heat the food item in the space between the first and second sidewalls.

37.-165. (canceled)
